(19) United States
(12) Patent Application Publication
(10) Pub. No.: US 2008/0284734 A1
(43) Pub. Date: Nov. 20, 2008

(54) Versatile Optical Mouse

(75) Inventor: Derk Visser, Veldhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., Eindhoven (NL)

(21) Appl. No.: 10/597,145

(22) PCT Filed: Jan. 12, 2005
(86) PCT No.: PCT/IB2005/005138

§ 371 Date: Aug. 5, 2008

Related U.S. Application Data
(60) Provisional application No. 60/536,883, filed on Jan. 15, 2004.

(51) Int. Cl. G06F 3/033

(52) U.S. Cl. 345/166

(57) ABSTRACT

Apparatus and method for generating a distinct “click” signal from a input device to a computer (541) or other device. The click signal is analogous to a right or left click of a conventional computer mouse. The click signal may be generated from an optical sensor unit by lifting and putting back a finger or other object from a window (112) of the optical sensor unit (500) and by simultaneously pressing a key (537) of the computer keyboard (532).

The invention relates to a method of simplifying construction and operation of a user interface, such as a computer mouse, a touch pad of a laptop computer or a graphics tablet, by measuring, identifying and characterizing contemporaneous inputs by a user from user input devices.

One of the input devices may comprise an optical sensor unit. A movement of an object and the optical sensor unit relative to each other, is measured, identified and characterized as a “click” signal. The measurement performed by the sensor unit includes the steps of illuminating an object surface with a measuring laser beam, capturing measuring beam radiation reflected by the object by a diode laser cavity that emits the measuring beam, measuring and identifying changes in operation of the laser caused by interference of the re-entering measuring beam radiation and the optical wave in the laser cavity. The invention also relates to an input device for carrying out the method and to an apparatus comprising such an input device.

A user's optical sensor unit is known from PCT patent application WO 02/37410 and a previous European patent application having filing number PCT/IB03/02474 (Applicants' docket no. NL 020567). The optical sensor unit of WO 03/37410 and PCT/IB03/02474, also called a “laser beetle,” is intended to be used, for example, in a handheld or laptop computer to move a cursor across a display, for example to select a function of a displayed menu. To select a function, or item, from a menu, a human finger (the object) is moved in a direction across a transparent window in the housing of the sensor unit. This movement is called a scroll action. The direction of another type of movement may be perpendicular to the direction of the scroll movement, for example. To activate the selected function the finger is moved in a direction perpendicular to said window. This movement is called a click action. The optical sensor unit may be small, because the optical sensors can be made very small. This implementation of the present invention in connection with an input device comprising an optical sensor unit, in particular, opens the way to many new applications. For example, a user's interface function can be built in a mobile phone for selecting items of a menu and for accessing Internet pages, in other hand-held apparatus or in a notebook computer.

The scroll-and-click input measuring methods and devices of WO 02/37410 and PCT/IB03/02474 are substantially more reliable and simpler and cheaper than prior art methods and devices. In PCT/IB03/02474 use is made of a concept that is new for the type of optical sensor unit mentioned here. This concept is a combination of the Doppler shift a moving object, like a human finger, introduces in a measuring laser beam and the so-called self-mixing effect in a diode laser, which supplies the measuring beam. Self-mixing is the phenomenon that radiation emitted by a diode laser and, after reflection from an object, re-entering the cavity of the diode laser induces a variation in the gain of the diode laser and thus in the radiation emitted by the laser.

The scroll-and-click method and devices of WO 02/37410 and PCT/IB03/02474 allow measuring both the speed and direction of the scroll movement and detecting a click action by means of two diode lasers measuring paths (sensors), which are, for example, oriented at opposite sharp angles relative to window of the device. This method is referred to as the vector decomposition method. The diode lasers may be supplied with periodically varying electrical currents and measuring signals generated during first and second half-periods may be compared to determine the direction of the scroll action.

The method of PCT/IB03/02474 (NL020567) is based on the insight that hitherto unused information in the measuring beam of a sensor can be used to detect the presence of a finger on the window of the optical sensor unit. A single click action consists of a fast movement of the finger toward the device window and back and a click action is preceded and succeeded by time intervals wherein no movement takes place. Another possibility is: put the finger on the window, retract the finger and put it gain on the window. Between the movement towards the window and the movement from the window, the finger is resting on the window for a short time interval. If such a resting, or presence on the window, of the finger is detected, it can be concluded that a click action takes place. This detection can be performed by the sensor, which measures scroll movement, so that a sensor and especially a diode laser can be saved. As the diode lasers are the most expensive components of the optical sensor unit, the method of PCT/IB03/02474 is substantially cheaper than a method, which uses two sensors, thus, two diode lasers. Saving one diode laser, moreover, means reducing the space, which should be reserved in the apparatus, which is provided with the capability to perform the method.

In the device of WO 02/37410 the high-frequency component of the sensor output signal is used for determining both a scroll and a click action. In the method of PCT/IB03/02474 use is made of the insight that the low-frequency and DC portion of the output signal comprise useable information about the presence of a finger on the window of the input device, and thus about a possible click action being performed. Also in PCT/IB03/02474, presence of an object on a window of the device is established by measuring variation in an electrical current for driving the diode laser. A third method disclosed in PCT/IB03/02474 is establishing the presence of an object on a window of the device by detecting presence of a pattern of output signal undulations, in periods corresponding in time with measuring beam pulse periods, which pattern is specific for the presence of the object on the window of the device.

An embodiment of the method of PCT/IB03/02474 detecting the presence of a finger, or another object, on the sensor unit window includes the combination of that method with the method according to the previous application having filing number PCT/IB03/02056 (PHNL020523). This combination provides the advantage that, by combining data obtained by means of the two methods the final measuring results are very reliable. For details about the processing of the different signals generated by a scroll action and a click action using the difference in time patterns of these signals and for embodiments of algorithms to perform this processing, reference is made to application PCT/IB03/02056 incorporated herein by reference.

A disadvantage of the known user interfaces as well as of other simplified input devices which avoid incorporating a separate hardware component for that purpose, is that most computer applications require two different clicks to be generated by a mouse, a left click for selecting an item on a menu and a right click for calling up a context-sensitive menu. The known device can, however, make only a single click. The operation of the device does, however, present the possibility of generating two distinct click signals.

It is an object of the invention to provide a new method of and apparatus for measuring a click movement, which adds, for example, a second kind of distinct click signal to the optical mouse of WO 02/237410 and PCT/IB03/02474. The method is such that, in an implementation of the present invention with respect to an input device using this type of optical sensor unit, use may be made of only one optical sensor for recognizing equivalents of a left click and a right click movement.

An additional type of click signal, analogous to, for example, a right click signal of a computer mouse, is generated by two contemporaneous actions. One action is generating a first type of click signal from a first input device, which may, for example, be from the laser beetle device. In the case of a laser beetle device, initiating the first type of click signal may be by lifting a finger from the window of the device and putting it back onto the window. The second click signal, e.g. analogous to a right click signal, is generated by a combined action of lifting the finger from the window of the device, putting it back onto the window and simultaneously initiating a second signal from another, second input device or second component of the same input device, such as by pressing a key of a computer keyboard. The combined occurrence of the first type of click signal from the first input device and the second signal from pressed key or other input from the second input device can be interpreted by a processor as the second, distinct kind of click

When the optical sensor unit is built into a keyboard, the choice of the key to serve as the source of the second input may be determined by the distance between the device and the key. A sufficiently small distance allows the actions of lifting the finger and pressing the key to be performed by one hand. The key or keys have preferably a second function in the keyboard. If for example the shift key is used as second input device, that key has as a second function the shift function. (If a key of a keyboard is to be pressed, it is preferable to use one such as “control-” or “alt-” that is also customarily used for similar purposes in connection with other inputs.)

In an alternative embodiment, the laser beetle can be built into a key of a keyboard. Touching the window without pressing the key is the first type of click; touching the window and pressing the key is the second type of click.

The first or second input device may additionally be one used to control the movement of a cursor, e.g. on a screen. In the method of WO 02/37410 the movement is caused by moving a finger over the window of the input device instead of moving a finger in a direction perpendicular to the window. When the input device employs two detection units, the movement of the cursor may be controlled over a two-dimensional surface.

These and other aspects of the invention will be apparent from and elucidated with reference to the embodiment(s) described hereinafter.

In the drawings:

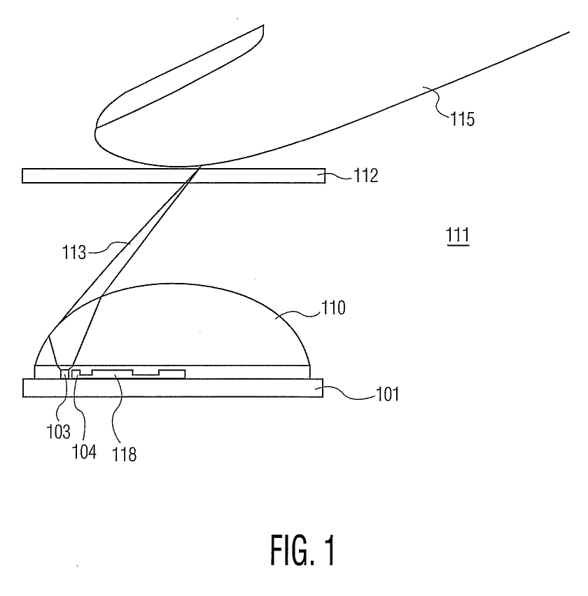

FIG. 1 shows, in cross-section, an embodiment of a known optical sensor unit, which uses a laser self-mixing effect and wherein the invention can be implemented;

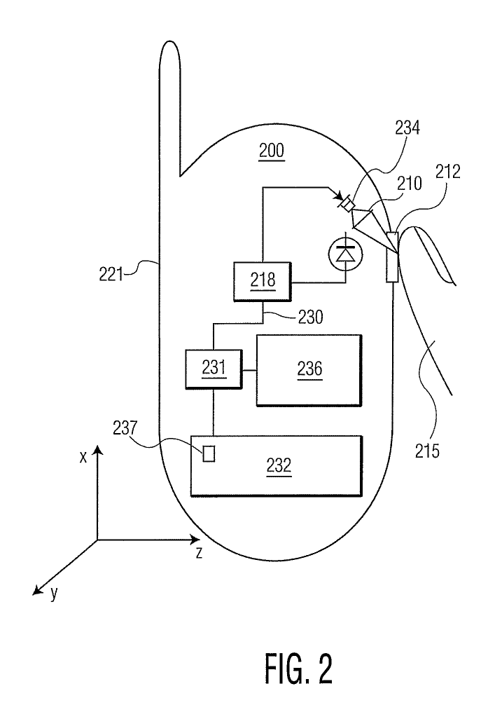

FIG. 2 shows a first embodiment of a an apparatus comprising a click device according to the invention;

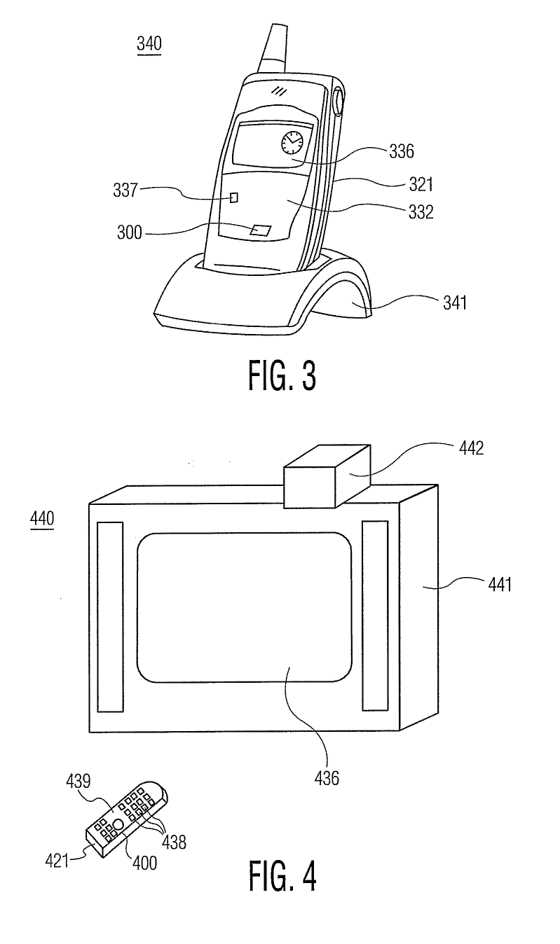

FIG. 3 shows a second embodiment of a an apparatus comprising a click device according to the invention;

FIG. 4 shows a third embodiment according to the invention, a TV set comprising a remote control equipped with such an input device; and

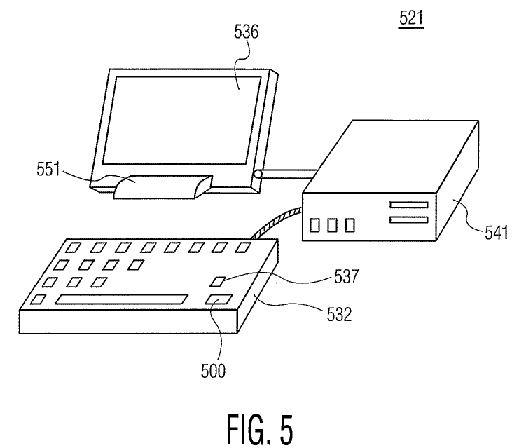

FIG. 5 shows a fourth embodiment according to the invention, a laptop computer equipped with such an input device.

FIG. 1 is a diagrammatic cross-section of an embodiment of a laser beetle optical sensor unit 111. The optical sensor unit 111 comprises at its lower side a base plate 101, which is a carrier for the diode laser or lasers, in this embodiment lasers of the type VCSEL (Vertical Cavity Surface Emitting Laser), and the detectors, for example photo diodes. In FIG. 1 only one diode laser 103 and its associated photo diode 104 is visible, but a second diode laser and associated detector (not shown) may also be provided on the base plate. The diode laser 103 emits a laser, or measuring, beam 113. At its upper side the device is provided with a transparent window 112 across which an object 115, for example a human finger is to be moved. A lens 110, for example a plane-convex lens is arranged between the diode lasers and the window. This lens focuses the measuring beam 113 at or near the upper side of the transparent window.

If an object 115, for example a human finger, is present at this position, it scatters the beam 113. The photo diode 104 measures radiation coming from the object 115 and scattered in the direction of the photo diode 104. The amount of radiation incident on the object 115, scattered by it and detected by the photo diode 104 is proportional to the intensity of the radiation emitted by the diode laser 103. Hence, changes in the intensity of the radiation emitted will be detected by the photo diode 104. A second measuring beam (not shown) may also be focused on the object, be scattered by the object and have part of the scattered radiation re-enters the cavity of the second diode laser.

FIG. 2 shows an embodiment of a user interface apparatus 200 used in a mobile phone 221, according to the invention. The user interface apparatus 200 comprises second input device 237 for a generating a signal contemporaneously with a sensed first click signal, a processor 231 and a first input device comprising a single optical sensor unit 211. The sensor unit 211 includes a diode laser and photo diode (monitor diode) assembly 234 and a lens 210 to converge the measuring beam from the diode laser on the window 212 of the input device. The monitor diode is coupled to an electronic circuit 218, which processes the monitor diode output signal and controls the laser drive current. Reference number 230 denotes the output of this circuit 218 to the processor 231 which comprises a storage device and program of instructions (not shown) configured to control functions of the apparatus 221 outside the input device, like mobile phone menus or a keyboard 232 and a display 236.

As the chief ray of the measuring beam is incident at a sharp angle on the window, it has a component in both a scroll direction x and the click direction z. A click movement will cause a change in the measuring beam radiation reflected back in the diode laser cavity. To determine whether or not a movement is a click movement that causes such a change, it is established from, for example, the occurrence of low frequency modulation or by counting the number of undulations in the monitor diode output signal, using a method disclosed in EP 02077437.8, whether the finger is resting or has rested on the window during a given time duration. If this is the case, it can be concluded that a click action is performed. Such an action consists of a fast movement in the z-direction of the finger 215 toward the window, a window touch of the finger and a fast retracting of the finger from the window, which is reported to the processor 231 by the processed monitor diode output signal 230 from the electronic circuit 218.

The processed diode output signal 230 is routed to the processor 231. When the processor 231 receives a processed diode output signal indicative of a cursor or scroll movement, the signal will be used to control instructions for movement of the cursor or for executing a scroll action. When the processed diode signal received is indicative of a click movement, the processor 231 will process the signal as the first type of click signal. When, however, the processor receives a processed diode signal indicative of a click movement and a contemporaneous signal from the user's pressing a second input device 237, here a designated key of the keyboard 232, it initiates an input to the program of instructions to indicate that the second input device (designated key) 237 has been pressed by the user at the same time as the click action and the click movement is to be processed as the second type of click signal. The processor 231 then initiates an action such as, for example, an appearance of a menu on the display screen 236.

FIG. 3 shows a cordless phone 340 provided with a user interface in which the invention is implemented. The cordless phone 340 is composed of a base station 341, which is connected to a phone or cable network and the movable apparatus 321 which can be used within an area with a radius of, for example, less than 100 m from the base station. In a similar way as described for the mobile phone 221, the movable apparatus 321 is provided with a first input device 300 and a display device 336, as discussed herein above. The movable apparatus 321 comprises a keyboard section 332 with second input device 337, here also a key of the keyboard 332. The second input device 337 key is designated to initiate an input to a program of instructions to indicate that a movement detected by the first input device 300 is to be processed as the second type of click signal. In FIG. 3 only a window of an optical sensor unit of the first input device 300 is shown. Preferably, in this and the other applications, the window has a convex shape so that the user can easily find the device position, even in poor lighting conditions. Moreover the window is then kept clear by means of finger movements, which wipe dust and grease from the window.

FIG. 4 shows a remote control unit 421 for use with a conventional TV set 440, which comprises a receiver and display apparatus 441 having a screen 436 and a set top box 442 to make the apparatus suitable for, for example, Internet communication. This box provides access to the Internet via a phone or cable network, and converts the signal received from the Internet into a signal that can be processed by the TV set in order to display the Internet information. As a user of the TV Internet should have the input device for Internet commands at hand, this user interface apparatus 400, including a optical sensor unit 439 and a second input device which is one of the buttons 438 of the remote control unit 421, can be integrated in the remote control unit 421. The optical sensor unit 439, with which the invention may be implemented and of which FIG. 4 shows only the window, may be arranged between the conventional buttons 438 of the remote control unit 421 or at any other position within reach of any of the person's fingers holding the remote control unit, with one of the buttons 438 being capable of being depressed to initiate a signal which identifies a click movement sensed by the optical sensor unit 439 as a the second type of click.

FIG. 5 shows a desktop computer configuration 521 wherein an optical sensor unit 500 can be applied in several ways to replace a conventional mouse, such as a trackball mouse. The computer configuration is composed of a keyboard 532, a computer box 541 and a monitor 536. The monitor may be a flat LCD monitor fixed in a support 551, as shown in the Figure, or a CRT monitor. An optical sensor unit 500 as described herein above may be an entity separate from the keyboard or, as shown in the Figure, integrated in the keyboard. The keyboard has a key as the second input device 537, capable of providing the second input to indicate the second type of click, so that a separate mouse and its cable to the computer box are no longer needed.

In a computer configuration, the input devices may be arranged in the display portion, instead of in the keyboard portion, for example in the cover of a laptop computer or in the cover of a hand-held computer. The present invention may also be incorporated, for example, in a lap or palm top computer or virtual pen and in displays other than computer displays. The processor may be configured to recognize depressing of any key or part of an input device as indicating a second click signal. The first type of click signal may also be identified as such by depressing a second designated key contemporaneously with the click signal.

Finally, the above-discussion is intended to be merely illustrative of the present invention and should not be construed as limiting the appended claims to any particular embodiment or group of embodiments. For example, the processor 231 may be a dedicated processor for performing the function in accordance with the present invention or may be a general-purpose processor wherein only one of many functions operates for performing in accordance with the present invention. The processor may operate utilizing a program portion, multiple program segments, or may be a hardware device utilizing a dedicated or multi-purpose integrated circuit. Each of the systems utilized may also be utilized in conjunction with further systems. Thus, while the present invention has been described in particular detail with reference to specific exemplary embodiments thereof, it should also be appreciated that numerous modifications and changes may be made thereto without departing from the broader and intended spirit and scope of the invention as set forth in the claims that follow. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference numerals in the claims are for illustration purposes only and do not limit their protective scope;

d) several “means” may be represented by the same item or hardware or software implemented structure or function; and

e) each of the disclosed elements may be comprised of hardware portions (e.g., discrete electronic circuitry), software portions (e.g., computer programming), or any combination thereof.

1. An apparatus comprising:
a first input device capable of generating a first output;
a second input device capable of generating a second output; and
a processor configured to receive the first output and the second output,
the processor comprising a program of instruction programmed to identify the first output as one of at least two types of click signal, when the first output is contemporaneous with the second output.

2. The apparatus of claim 1, wherein
the first input device comprises an optical sensor unit including a laser configured to generate a measuring beam, measuring means for measuring changes in operation of the laser from interference of the measuring beam radiation reflected by an object and re-entering the laser cavity and in the optical wave in the cavity; and
means for supplying the first output, based on the measured changes in operation of the laser, the output signal corresponding to a movement of the object relative to the input device, the movement comprising a click movement.

3. A mobile phone comprising the apparatus claimed in claim 1.

4. A cordless phone comprising the apparatus claimed in claim 1.

5. A remote control unit comprising the apparatus claimed in claim 1.

6. A computer comprising the apparatus claimed in claim 1.

7. The computer of claim 6 wherein the processor is a CPU of the computer and a click signal generated in response to the identification of the first output is processed in substantially the same way as a right click signal input from a conventional computer mouse.

8. A keyboard for a desktop computer comprising the apparatus claimed in claim 1.

9. The computer of claim 8 wherein a click signal generated in response to the identification of the first output is transmitted to a keyboard processor of the keyboard and processed in substantially the same way as a right click signal input from a conventional computer mouse.

10. The apparatus of claim 1, wherein the first input device comprises a graphics tablet.

11. The apparatus of claim 1, wherein the first input device comprises a touch pad of a laptop computer.

12. A method of operation of a user interface comprising:
generating a first output from a first input device;
generating a second output from a second input device; and
identifying the first output as one of at least two types of click signal, when the first output is contemporaneous with the second output.

13. The method of claim 12 wherein generating a first output from a first input device comprises:
making a click movement of an object with respect to a window of an optical sensor unit of the first input device, the click movement being detected by a laser of the optical sensor unit; and
transmitting to a processor a signal in response to the detected click movement.

14. The method of claim 12 wherein generating a second output from a second input device comprises pressing a button of a remote control unit.

15. The method of claim 12 further comprising processing and generating a display in response to the identified click signal in substantially the same way that such processing and generating would take place in a conventional computer system in response to a right click signal of a conventional computer mouse.

16. A program storage device tangibly embodying a program of instructions executable by a processor to perform a method for operation of a user interface comprising:
generating a first output from a first input device;
generating a second output from a second input device; and
identifying the first output as one of at least two types of click signal, when the first output is contemporaneous with the second output.
